(19) United States
(12) Patent Application Publication
(10) Pub. No.: US 2021/0161156 A1
(43) Pub. Date: Jun. 3, 2021

(54) METHOD FOR PRODUCING BAKED CONFECTIONERY

(71) Applicant: J-OIL MILLS, INC., Tokyo (JP)

(72) Inventors: Mina YOSHIMURA, Tokyo (JP); Keisuke SHINODA, Tokyo (JP); Yuya NAGAHATA, Tokyo (JP); Jun IMAGI, Tokyo (JP)

(21) Appl. No.: 17/262,988

(22) PCT Filed: Jul. 26, 2019
(86) PCT No.: PCT/JP2019/029528

§ 371 Date: Jan. 25, 2021

(30) Foreign Application Priority Data
Aug. 3, 2018 (JP) 2018-147254
Oct. 19, 2018 (JP) 2018-197980

(51) Int. Cl. A21D 2/18; A21D 13/80; A21D 2/38; A21D 8/06; A21D 8/02

(52) U.S. Cl. CPC A21D 2/186; A21D 13/80; A21D 8/02; A21D 8/06; A21D 2/38

(57) ABSTRACT

A method for producing a baked confectionery, the method includes: preparing a dough of a baked confectionery, the dough containing a component (A) which is a granular product containing equal to or more than 75% by mass of starch and in which the granular product contains, as he starch, equal to or more than 3% by mass and equal to or less than 45% by mass of molecular weight-reduced starch of starch having an amylose content of equal to or more than 5% by mass, where the molecular weight-reduced starch has a peak molecular weight of equal to or more than 3×10³ and equal to or less than 5×10⁴, and the granular product has a degree of swelling of equal to or more than 5 and equal to or less than 20 in cold water at 25° C., and the dough having a moisture content (excluding moisture in a powder raw material) of equal to or more than 18% by mass and equal to or less than 55% by mass; and heating the dough, in which in the preparing the dough of a baked confectionery, a blending amount of the component (A) with respect to the moisture content is equal to or more than 0.01 and equal to or less than 0.24, in terms of a mass ratio.

### TECHNICAL FIELD

The present invention relates to a method for producing a baked confectionery.

### BACKGROUND ART

In the related art , various methods have been proposed to improve a texture and a taste of a baked confectionery such cakes, and some attempts such as adding additives to a raw wheat flour or adjusting a particle size distribution of a flour have been made. Among them, there is a method that improves the texture of confectionery by adjusting moisture in some way.

Patent Documents 1 to 3 describe techniques for improving the texture of baked confectionery by adjusting the moisture of a dough.

Patent Document 1 discloses a method for producing cakes by a common procedure, in which tapioca starch that has absorbed water in advance is blended in a prepared dough for a cake, so that the net amount used is equal to or less than 40% by weight with respect to a total amount of starch used. According to this method, it is described that it is possible to provide a method for producing cakes by which low-calorie cakes are easily obtained and a flavor or a texture when stored refrigerated is good.

Patent Document 2 discloses a method for producing cakes with high moisture content, which have a moisture content of equal to or more than 30% by weight, in which cakes are baked, and then, water or a liquid substance containing water and an additive selected from a sweetener, a dairy product, a coloring agent, a flavor, alcoholic beverages, and other additives is applied to the cakes or the cakes is impregnated therewith, and the cakes are heated.

According to this method, it is described that a cake with a high moisture content which has a uniform moisture distribution in the cake, is palatable, and, moreover, becomes a frozen cake with a high moisture content without becoming rough due to precipitation of ice crystals when frozen.

Patent Document 3 discloses a method for producing cakes, including; preparing a dough in which 300 to 500 parts by mass of moisture, 50 to 150 parts by mass of an oil and fat containing 10 to 90% by mass of diacylglycerol, and 45 to 200 parts by mass of egg yolk in terms of dry mass are contained with respect to 100 parts by mass (parts by dry mass) of a cereal flour, and 30% to 100% by mass of starch in the cereal flour was pregelatinized by a hot water kneading, method; and baking the dough to produce the cakes . According to this, it is described that it is possible to provide cakes which has excellent texture such as a melting feeling in a mouth, a moist feeling, and a crisp feeling and having a large specific volume volume) that does not fall off after baking.

### RELATED DOCUMENT

### Patent Document

[Patent Document 1] Japanese Unexamined Patent Publication No. H6-141755

[Patent Document 2] Japanese Unexamined Patent Publication No. S54-160763

[Patent Document 3] Japanese Unexamined Patent Publication No. 2010-252763

### SUMMARY OF THE INVENTION

### Technical Problem

However, the present inventors adjusted moisture contained in a dough and confirmed a texture of a baked confectionery. As a result there was a case where the baked confectionery after baking was not sufficient in a moist feeling or meltability in mouth and was felt it hard to swallow.

### Solution to Problem

Therefore, as a result of intensive studies, the present inventors have found that when incorporating a specific component into a dough of a baked confectionery, the baked confectionery that is moist, has excellent meltability in mouth, and is easy to swallow is obtainable, and completed the present invention.

That is, according to the present invention, there is provided a method for producing a baked confectionery, the method including: preparing a dough of a baked confectionery, containing a component (A) below and having a moisture content (excluding moisture in a powder raw material) of equal to or more than 18% by mass and equal to or less than 55% by mass; and heating the dough, in which in the preparing the dough of a baked confectionery, a blending amount of the component (A) with respect to the moisture content is equal to or more than 0.01 and equal to or less than 0.24, in terms of a mass ratio, The component (A) is a granular product containing equal to or more than 75% by mass of starch, in which the granular product contains, as the starch, equal to or more than 3% by mass and equal to or less than 45% by mass of molecular weight-reduced starch of starch having an amylose content of equal to or more than 5% by mass, where the molecular weight-reduced starch has a peak molecular weight of equal to or more than 3×10 and equal to or less than 5×10⁴, and the granular product has a degree of swelling of equal to or more than 5 and equal to or less than 20 in cold water at 25° C.

The blending amount of the component (A) is preferably equal to or more than 0.2% by mass and equal to or less than 30% by mass with respect to the powder raw material.

A moisture content of the baked confectionery is preferably equal to or more than 18% by mass and equal to or less than 45% by mass.

The baked confectionery is preferably one selected from the group consisting of a pound cake, a roll cake, baumkuchen, a sponge cake, a pancake, a waffle, a corn dog, and a whoopie pie.

A content of the component (A) under a sieve having an opening of 0.5 mm is preferably equal to or more than 65% by mass and equal to or less than 100% by mass.

The dough preferably contains a cereal flour.

In addition, according , the present invention, there is provided a dough of baked confectionery, including: a component (A) below, in which a moisture content (excluding moisture in a powder raw material) is equal to or more than 18% by mass and equal to or less than 55% by mass, and a blending amount of the component (A) with respect to the moisture content is equal to or more than 0.01 and equal to or less than 0.24, in terms of a mass ratio. The component (A) is a granular product containing equal to or more than 75% by mass of starch, in which the granular product contains, as the starch, equal to or more than 3% by mass and equal to or less than 45% by mass of molecular weight-reduced starch of starch having an amylose content of equal to or more than 5% by mass, where the molecular weight-reduced starch has a peak molecular weight of equal to or more than 3×10³ and equal to or less than 5×10⁴, and the granular product has a degree of swelling of equal to or more than 5 and equal to or less than 20 in cold water at 25° C.

In addition, according to the present invention, there is provided a method for improving meltability in mouth of a baked confectionery, in which a moisture content (excluding moisture in a powder raw material) of a dough of a baked confectionery is equal to or more than 18% by mass and equal to or less than 55% by mass, and a component (A) below is contained in the dough of a baked confectionery. The component. (A) is a granular product containing equal to or more than 75% by mass of starch, in which the granular product contains, as he starch, equal to or more than 3% by mass and equal to or less than 45% by mass of molecular weight-reduced starch of starch having an amylose content of equal to or more than 5% by mass, where the molecular weight-reduced. starch has a peak molecular weight of equal to or more than 3×10³ and equal to or less than 5×10⁴, and the granular product has a degree of swelling of equal to or more than 5 and equal to or less than 20 in cold water at 25° C.

A predetermined combination of each of these configurations, or a case obtained by changing the expression of the present invention among a method, a device, and the like is also effective as an aspect of the present invention.

For example, according to the present invention, a baked confectionery obtainable by the production method according to the present invention and a food using the same are provided.

### Advantageous Effects of Invention

According to the present invention, it is possible to obtain a baked confectionery that is moist, has excellent meltability in mouth, and is easy to swallow. The term the “excellent meltability in mouth” indicates that when put. in the mouth, it takes a short time to be mixed with saliva on the tongue and to dissolve and disappear.

### DESCRIPTION OF EMBODIMENTS

Hereinafter, embodiments of the present invention will be described with reference to specific examples of each component. Each component may be used alone or two or more kinds thereof may be used in combination.

(Dough of baked confectionery)

In the present embodiment, a dough of a baked confectionery (hereinafter, also referred to as “dough for a baked confectionery” includes a component (A) below, and has a moisture content (excluding moisture in a powder raw material) of equal to or more than 18% by mass and equal to or less than 55% by mass.

Component (A) A granular product containing equal to or more than 75% by mass of starch, in which the granular product contains, as the starch, equal to or more than 3% by mass and equal to or less than 45% by mass of molecular weight-reduced starch of starch having, an amylose content of equal to or more than 5% by mass, where the molecular weight-reduced starch has a peak. molecular weight of equal to or more than 3×10³ and equal to or less than 5×10⁴, and the granular product has a degree of swelling of equal to or more than 5 and equal to or less than 20 in cold water at 25° C. Moreover, in preparing the dough of baked confectionery, a blending amount of the component (A) with respect to the moisture content is equal to or more than 0.01 and equal to or less than 0.24, in terms of a mass ratio.

Hereinafter, each component that is a raw material for the dough for a baked confectionery will be described.

(Component (A))

The component (A) is a granular product containing equal to or more than 75% by mass of starch. Moreover, in the component (A), the granular product contains, as the starch, in the equal to or more than 3% by mass and equal to or less than 45% by mass of molecular weight-reduced starch of starch having an amylose content of equal to or more than 5% by mass, where the molecular weight-reduced starch has a peak molecular weight of equal to or more than 3×10³ and equal to or less than 5×10⁴, and the granular product has a degree of swelling of equal to or more than 5 and equal to or less than 20 in cold water at 25° C.

Hereinafter, the component (A) will be described in more detail

The content of the starch in the component (A) is preferably equal to or more than 80% by mass, and sill more preferably, equal to or more than 85% by mass, from a viewpoint of improving a moist feeling, meltability in mouth, and ease of swallowing.

Also, an upper limit of the content of the starch in the component (A) is not limited and is equal to or less than 100% by mass, or may also be, for example, equal to or less than 99.5% by mass and equal to or less than 99% by mass, according to properties of the baked confectionery.

Here, the content of the starch in the component (A) is the content with respect to an entirety of the component (A).

In addition, the component. (A) contains, as the starch, a molecular weight-reduced starch which uses starch having an amylose content of equal to or more than 5% by mass, as a raw material in a specific ratio, and a molecular weight-reduced starch having a specific size is used. That is, the starch in the component W contains equal to or more than 3% by mass and equal to or less than 45% by mass of the molecular weight-reduce-, starch which uses the starch having the amylose content of equal to or more than 5% by mass as a raw material in the component (A), and the peak molecular weight of the molecular weight-reduced starch is equal to or more than 3×10³ and equal to or less than 5×10⁴.

A lower limit of the peak molecular weight of the molecular weight-reduced starch is equal to or more than 3×10³, and preferably equal to or more than 8×10³, from the viewpoint of improving the moist feeling, the meltability in mouth, and the ease of swallowing. Also, an upper limit of the peak molecular weight of the molecular weight-reduced starch is equal to or less than 5×10⁴, preferably to equal to or less than 3×10⁴, and still more preferably equal to or less than 1.5×10⁴, from the viewpoint of improving the meltability in mouth. A measurement method of the peak molecular weight of the molecular weight-reduced starch will be described in a section of Examples.

From a viewpoint of excellent production stability, the molecular weight-reduced starch is preferably one or more selected from the group consisting of acid-treated starch, oxidation-treated starch, or enzyme-treated starch, and more preferably the acid-treated starch.

A condition of the acid treatment is not limited, and the treatment can be performed as follows, for example.

The starch having the amylose content of equal to or more than 5% by mass and water are added. to a reaction device, and then acid is further added thereto. Alternatively, acid water, in which an inorganic acid is previously dissolved in water, and the starch as a raw material are added to the reaction device. From a viewpoint of more stably performing the acid treatment, it is desirable that a total amount of the starch in the reaction is in a state of being uniformly dispersed in an aqueous phase or in a slurry state . For the purpose, a concentration of the starch slurry in the acid treatment is adjusted to be in a range, for example, equal to or more than 10% by mass and equal to or less than 50% by mass, and preferably equal to or more than 20% by mass and equal to or less than 40% by mass. When the slurry concentration is too slurry viscosity may increase, and it may be difficult to stir the slurry uniformly, in some cases.

Specific examples of the acid used for the acid treatment include inorganic acids such as hydrochloric acid, sulfuric acid, and nitric acid, which can be used regardless of a kind, purity, and the like.

In the acid treatment reaction, for example, a concentration of the inorganic acid during the acid treatment is preferably equal to or more than 0.05 Normality (N) and equal to or less than 4 N, more preferably equal to or more than 0.1 N and equal to or less than 4 N, and still more preferably equal to or more than 0.2 N and equal to or less than 3 N. In addition, a reaction temperature is preferably equal to or higher than 30° C, and equal. to or lower than 70° C., more preferably equal to or higher than 35° C, and equal to or lower than 70° C., and still more preferably equal to or higher than 35° C, and equal. to or lower than 65° C. A reaction time is preferably equal to or longer than 0.5 hours and equal to or shorter than 120 hours, more preferably equal to or longer than 1 hour and equal to or shorter than 72 hours, and still more preferably equal to or longer than 1 hour and equal to or shorter than 48 hours.

A lower limit of a content of the molecular weight-reduced starch in the component (A) is equal to or more than 3% by mass, preferably equal to or more than 8% by mass, and still more preferably equal to or more than 13% by mass, with respect to an entirety of the component (A), from the viewpoint of improving the moist feeling, and the meltability in mouth, and the ease of swallowing.

On the other hand, an upper limit of the content of the molecular weight-reduced starch in the component (A) is equal to or less than 45% by mass, preferably equal to or less than 35% by mass, and still more preferably equal to or less than 25% by mass, with respect to the entirety of the component (A), from a viewpoint of suppressing flouriness.

In addition, the amylose content in the raw material starch of the molecular weight-reduced starch is equal to or more than 5% by mass, preferably equal to or more than 12% by mass, more preferably equal to or more than 22% by mass, still more preferably equal to or more than 45% by mass, still further preferably equal to or more than 55% by mass, and even more preferably equal to or more t an 65% by mass, An upper limit of the amylose content in the raw material starch of the molecular weight-reduced, starch is not limited, and is equal to or less than 100% by mass, preferably equal to or less than 90% by mass, and more preferably equal to or less than 80% by mass.

As the starch which is the raw material of the molecular weight-reduced starch and has the amylose content of equal to or more than 5% by mass, one or more selected from the group consisting of high amylose corn starch, corn starch, tapioca starch, sweet potato starch, potato starch, wheat starch, high amylose wheat starch, rice starch, and processed starch obtained by processing these raw materials chemically, physically, or enzymatically can be used. From the viewpoint of improving the moist feeling, the meltability in mouth, and ease of swallowing, it is preferable to use one or more selected from the hi h amylose corn starch, the corn starch, and the tapioca starch, and it is more preferable to use the high amylose corn starch. The high amylose corn starch having the amylose content of equal to or more than 40% by mass is available. The starch having the amylose content of equal to or more than 5% by mass is more preferably corn starch having the amylose content of equal to or more than 40% by mass.

Also, the degree of swelling of the component (A) in cold water is equal to or more than 5, preferably equal to or more than 6, and still more preferably equal to or more than 6.5, from the viewpoint of improving the moist feeling and the meltability in mouth.

Furthermore, from the viewpoint of improving the ease of swallowing, the degree of swelling of the component (A) in cold water is equal to or less than 20, preferably equal to or less than 17, and stillmore preferably equal to or less than 15.

Here, the degree of swelling of the component (A) in cold water is measured by the following method.

(1) A sample is dried by heating at 125° C. using a moisture meter (model number MX-50, manufactured by Kensei Kogyo Co., Ltd.) to measure the moisture, and the mass of dry matter is calculated from a moisture value obtained.

(2) 1 g of the sample in terms of the mass of dry matter is in a state of being dispersed in 50 mL of water at 25° C., gently stirred in a constant temperature bath at 25° C. for 30 minutes, and then centrifuged at 3000 rpm for 10 minutes (Centrifuge: Hitachi desktop centrifuge CT 6E type, manufactured by Hitachi Koki Co., Ltd.,; Rotor: T4SS type swing rotor; and Adapter: 50TC×2S adapter), and separated into a sediment layer and a supernatant layer.

(3) The supernatant layer is removed, the mass of the sediment layer is measured, and this mass is set as B (g).

(4) The mass when the sediment layer is dried and solidified (105° C., constant weight) is set as C (g).

(5) A value obtained by dividing B by C is set as the degree of swelling in cold water.

The content of the component (A) under a sieve having an opening of 0.5 mm in the JIS-Z8801-1 standard is preferably equal to or more than 55% by mass and equal to or less than 100% by mass, more preferably equal to or more than 80% by mass and equal to or less than 100% by mass, still more preferably equal to or more than 90% by mass and equal to or less than 100% by mass, and even more preferably 100% by mass, from the viewpoint of making the meltability in mouth preferable.

Furthermore, the content of the component (A) under a sieve having an opening of 0.25 mm and on a sieve having an opening of 0.075 mm in the JIS-Z8801-1 standard is preferably equal to or more than 20% by mass and equal to or less than 100% by mass, more preferably equal to or more than 30% by mass and equal to or less than 98% by mass, still more preferably equal to or more than 40% by mass and equal to or less than 95% by mass, and still further preferably equal to or more than 60% by mass and equal to or less than 95% by mass, from the viewpoint of improving the meltability in mouth.

From the same viewpoint, the content of the component (A) under a sieve having an opening of 0.25 mm and on a sieve having an opening of 0.075 mm in the JIS-Z8801-1 standard is preferably equal to or more than 20% by mass, more preferably equal to or more than 30% by mass, still more preferably equal to or more than 40% by mass, and still further preferably equal to or more than 60% by mass, and preferably equal to or less than 100% by mass, more preferably equal to or less than 98% by mass, and still more preferably equal to or less than 95% by mass.

In addition, the content of the component (A) on, a sieve having an opening of 0.038 mm in the JIS-Z8801-1 standard is preferably equal to or more than 90% by mass, more preferably equal to or more than 92% by mass, and still more preferably equal to or more than 95% by mass, from the viewpoint of stably obtaining the granular component (A).

Also, an upper limit of the content on the sieve having the opening of 0.038 mm is equal to or less than 100% by mass, and may be, for example, equal to or less than 99% by mass, or equal to or less than 98% by mass.

Here, the content of the component (A) on or under a predetermined sieve is a content of a fraction on or under the sieve with respect to the entirety of the component (A) when the component (A) has passed through the predetermined sieve.

In the present embodiment, the component contains starch other than the molecular weight-reduced starch.

In the present embodiment, various starch can be used as a starch component other than the molecular weight-reduced starch in the component (A). Specifically, starch generally available on the market can be selected depending on use. For example, in a case of starch for foods, regardless of a kind, one or more kinds of starch such as corn starch, potato starch, tapioca starch, and wheat starch; processed starch obtained by processing these starch chemically, physically, or enzymatically; and the like can be appropriately selected, Preferably, one or more starch selected from the group consisting of the corn starch, the wheat starch, the potato starch, the tapioca starch, and cross-linked starch thereof may be contained, and more preferably the corn starch may be contained.

In addition, a component other than the starch can be blended with the component (A) in the present embodiment.

Specific examples of the component other than the starch include a pigment, an insoluble salt such as calcium carbonate, and calcium sulfate. It is preferable to blend the insoluble salt, and it is more preferable that a blending amount of the insoluble salt is equal to or more than 0.1% by mass and equal to or less than 2% by mass.

Next, a method for producing the component (A) will be described. The method for producing the component (A) includes, for example, the following steps.

(Preparing molecular weigh -reduced starch) A step of reducing the molecular weight of the raw material starch having the amylose content of equal to or more than 5% by mass to obtain the molecular weight-reduced starch having a peak molecular weight of equal to or more than 3×10³ and equal to or less than 5×10⁴.

(Granulation) A step of granulating, by heat gelatinization, the raw material in which equal to or more than 3% by mass and equal to or less than 45% by mass of the molecular weight-reduced starch is contained, and the total amount of molecular weight-reduced starch and starch other than the molecular weight-reduced starch is equal to or more than 75% by mass.

The step of preparing the molecular weight-reduced starch is a step of decomposing the starch having the amylose content of equal to or more than 5% by mass into the molecular weight-reduced starch. The decomposition referred to here refers to decomposition accompanied by molecular weight reduction of starch, and examples of a typical decomposition method include decomposition by an acid treatment or an oxidation treatment, and an enzyme treatment. Among the treatments, the acid treatment is preferable from the viewpoints of a decomposition rate or costs, and reproducibility of a decomposition reaction.

Further, in the granulation step, a general method used for granulating starch can be used, and it is preferable to use a general method used for heat gelatinization of starch, in terms of achieving, a predetermined degree of swelling in cold water. Specifically, a method using a machine such as a drum dryer, a jet cooker, an extruder, or a spray dryer is known. However, in the present embodiment, from the viewpoint of more reliably obtaining the component (A) in which the degree of swelling in cold water satisfies the above-mentioned specific condition, the heat gelatinization with the extruder or the drum dryer is preferable, and the extruder is more preferable.

In a case of an extruder treatment, usually, water is added to a raw material containing starch to adjust the moisture content to about 10% to 60% by mass, and then heated and swelled, for example, in conditions of a barrel temperature of 30° C. to 200° C., an outlet temperature of 80° C. to 180° C., a screw rotation speed of 100 to 1.000 rpm, and a heat treatment time of 5 to 60 seconds.

In the present embodiment, for example, by the step of heat-gelatinizing the specific raw material, the component (A) in which the degree of swelling in cold. water satisfies a specific condition can be obtained. In addition, the component (A) may be obtained by, as needed, pulverizing and sieving a granulated product obtained by heat gelatinization and appropriately adjusting a size thereof.

The component (A) obtained as described above is a granular product containing the molecular weight-reduced starch, and is configured such that all of the starch content, the degree of swelling, in cold water, and the peak molecular weight of the molecular weight-reduced starch satisfy specific conditions. Therefore, a texture of the baked confectionery can further be improved.

(Powder raw Material)

Next, the powder raw material will be described. The powder raw material is a raw material that is blended in a powdery form in the dough for a baked confectionery.

The component (A) is a powder raw material. Also, the dough for a baked confectionery preferably further contains a powder raw material other than the component (A).

Specific examples of the powder raw material of the dough for a baked confectionery other than the component (A) include a cereal flour such as a wheat flour, a rice flour, and a soybean flour; proteins such as gluten and soy protein; polysaccharides such as corn starch, esterified starch, etherified starch, pregelatinized starch, resistant starch, and dextrin; powdered sweeteners such as sugar, fructose, glucose, isomerized sugar, converted sugar, oligosaccharide, trehalose, sugar alcohol (such as maltitol, erythritol, sorbitol, xylitol, and lactitol), aspartame, acesulfam potassium, advantame, sucralose, ariteme, neotheme, saccharin, and stevia extract; milks such as skim milk powder, full-fat milk powder, and cheese powder; table salt; dietary fiber such as bran, cellulose, and indigestible dextrin; eggs such as egg white powder and whole egg powder; thickening polysaccharides such as guar gum and alginate; an emulsifier; flavored powders such as a cocoa powder and a matcha powder; and a flavor improver.

The dough for a baked confectionery preferably contains the cereal flour, as the powder raw material other than the component (A).

Also, the dough for a baked confectionery preferably contains one or two kinds selected from the wheat flour and the rice flour, more preferably contains the wheat flour, and still more preferably contains a soft flour, as the powder raw materials other than the component (A).

The content of the component (A) in the powder raw material is preferably equal to or more than 0.2% by mass and equal to or less than 30% by mass, more preferably equal to or more than 0.5% by mass and equal to or less than 25% by mass, still more preferably equal to or more than 1.0% by mass and equal to or less than 20% by mass, more preferably equal to or more than 1.0% by mass and equal to or less than 15% by mass, still more preferably equal to or more than 1.0% by mass and equal to or less than 12% by mass, still further preferably equal to or more than 1.2% by mass and equal to or less than 10% by mass, and even more preferably equal to or more than 2% by mass and equal to or less than 8% by mass, from the viewpoint of improving the meltability in mouth. From the same viewpoint, the content of the component (A) in the powder raw material is preferably equal to or more than 0.2% by mass, more preferably equal to or more than 0.5% by mass, still more preferably equal to or more than 1.0% by mass, still further preferably equal to or more than 1.2% by mass, and even more preferably equal to or more than 2% by mass, and preferably equal to or less than 30% by mass, more preferably equal to or less than 25% by mass, still more preferably equal to or less than 20% by mass, still further preferably equal to or less than 15% by mass, even more preferably equal to or less than 12% by mass, even further preferably equal to or less than 10% by mass, and further more preferably equal to or less than 8% by mass.

Furthermore, in a case of the roll cake, the content of the component (A) in the powder raw material is preferably equal to or more than 0.2% by mass and equal to or less than 30% by mass, more preferably equal to or more than 0.5% by mass and equal to or less than 25% by mass, still more preferably equal to or more than 1.0% by mass and equal to or less than 20% by mass, and still further preferably equal to or more than 1.2% by mass and equal to or less than 17% by mass, from the viewpoint of improving the meltability in mouth. From the same viewpoint, in the case of the roll cake, the content of the component (A) in the powder raw material is preferably equal to or more than 0.2% by mass, more preferably equal to or more than 0.5% by mass, still more preferably equal to or more than 1.0% by mass, and still further preferably equal to or more than 1.2% by mass, and preferably equal to or less than 30% by mass, more preferably equal to or less than 25% by mass, still more preferably equal to or less than 20% by mass, and still, further preferably equal to or less than 17% by mass.

Here, the content of the component (A) is the content of the component (A) with respect to the entire powder raw material blended in the dough.

(Moisture Content in Dough)

The dough for a baked confectionery contains moisture other than the moisture in the powder raw material. The moisture referred to here includes the moisture of a liquid used instead of water, such as milk, soymilk, fruit juice, and vegetable juice, but the water is preferable from the viewpoint of improving the meltability in mouth. In a case where a non-powder raw material such as an edible oil or fat composition; eggs such as whole eggs, egg yolks, and egg whites; and a liquid sweetener such as starch syrup, liquid sugar, brown sugar, and honey contains moisture, the moisture in the non-powder raw material is included in the moisture of the dough for a baked confectionery.

The moisture content (excluding moisture in the powder raw material) in the dough for a baked confectionery is equal to or more than 18% by mass, preferably equal to or more than 20% by mass, and more preferably equal to or more than 21% by mass with respect to the entirety of the dough for a baked confectionery, from the viewpoints of the moist feeling, the meltability in mouth, and the ease of swallowing. Also, from the same viewpoint, the moisture content (excluding the moisture in the powder raw material) in the dough for a baked confectionery is equal. to or less than 55% by mass, preferably equal to or less than 50% by mass, more preferably equal to or less than 47% by mass, still more preferably equal to or less than 41% by mass, still further preferably equal to or less than 39% by mass, and even more preferably equal to or less than 37% by mass, with respect to the entirety of the dough for a baked confectionery.

In addition, in the case of the roll cake, the moisture content (excluding moisture in the powder raw material) in the dough for a baked confectionery is equal to or more than 18% by mass, preferably equal to or more than 25% by mass, more preferably equal to or more than 30% by mass, and still further preferably equal to or more than 35% by mass, with respect to the entirety of the dough for a baked confectionery, from the viewpoints of the moist feeling, the meltability in mouth, and the ease of swallowing. Also, from the same viewpoint, the moisture content (excluding moisture in the powder raw material) in the dough for a baked confectionery is equal to or less than 55% by mass, preferably equal to or less than 50% by mass, and more preferably equal to or less than 47% by mass, with respect to the entirety of the dough for a baked confectionery.

Furthermore, the blending amount of the component (A) with respect to the moisture content, in the dough for a baked confectionery is preferably equal to or more than 0.01 and equal to or less than 0.24, more preferably equal to or more than 0.02 and equal to or less than 0.20, and still more preferably equal to or more than 0.03 and equal to or less than 0.14, still further preferably equal to or more than 0.04 and equal to or less than 0.12, even more preferably equal to or more than 0.05 and equal to or less than 0.1, further more preferably equal to or more than 0.058 and equal to or less than 0.08, and even further preferably equal to or more than 0.06 and equal to or less than 0.08, in terms of a mass ratio, from the viewpoint of improving the meltability in mouth and the viewpoint of the moist feeling.

Also, from the same viewpoint, the blending amount of the component (A) with respect to the moisture content is preferably equal to or more than 0.05 and more preferably equal to or more than 0.08, and preferably equal to or less than 0.15 and more preferably equal to or less than 0.12, in terms of a mass ratio.

Hereinafter, in cases where the baked confectionery is a sponge cake and a pound cake, specific examples of blending will be described.

In the case of the sponge cake, the moisture content (excluding moisture in the powder raw material) in the dough for a baked confectionery is equal to or more than 18% by mass, preferably equal to or more than 27% by mass, and more preferably equal to or more than 32% by mass, with respect to the entirety of the dough for a baked confectionery, from the viewpoints of the moist feeling, the meltability in mouth, and the ease of swallowing. Also, from a viewpoint of water removal, the moisture content in the dough for a baked confectionery is equal to or less than 55% by mass, preferably equal to or less than 50% by mass, more preferably equal to or less than 47% by mass, still more preferably e to or less than 41% by mass, still further preferably equal to or less than 39% by mass, even more preferably equal to or less than 36% by mass, and further more preferably equal to or less than 34% by mass, with respect to the entirety of the dough for a baked confectionery.

Furthermore, in the case of the sponge cake, the blending amount of the component (A) with respect to the moisture content, in the dough for a baked confectionery is, for example, equal to or more than 0.01 and equal to or less than 0.24, in terms of a mass ratio, and from the viewpoint of improving the meltability in mouth and the viewpoint of the moist feeling, preferably equal to or more than 0.03 and equal to or less than 0.14, and more preferably equal to or more than 0.05 and equal to or less than 0 and still more preferably equal to or more than 0.06 and equal to or less than 0.08, in terms of a mass ratio. From the same viewpoints, in the case of the sponge cake, the blending amount of the component (A) with respect to the moisture content, in the dough for a baked confectionery is, for example, equal to or more than 0.01, preferably equal to or more than 0.03, more preferably equal to or more than 0.05, and still more preferably equal to or more than 0.06, and is, for example, equal to or less than 0.24, preferably equal to or less than 0.14, more preferably equal to or less than 0.1, and still more preferably equal to or less than 0.08, in terms of a mass ratio.

In the case of the pound cake, the moisture content (excluding moisture in the powder raw material) in the dough for a baked confectionery is equal to or more than 18% by mass and equal to or less than 55% by mass, preferably equal to or more than 18% by mass and equal to or less than 41% by mass, more preferably equal to or more than 21% by mass and equal to or less than 34% by mass, and still further preferably equal to or more than 23% by mass and equal to or less than 28% by mass, with respect to the entirety of the dough for a baked confectionery, from the viewpoint of improving the meltability in mouth. From the same viewpoint, in the case of the pound cake, the moisture content is equal to or more than 18% by mass, preferably equal to or more than 21% by class, and more preferably equal to or more than 23% by mass, and is equal to or less than 55% by mass, preferably, equal to or less than 41% by mass, more preferably, equal to or less than 34% by mass, and still further preferably, equal to or less than 28% by mass, with respect to the entirety of the dough for a baked confectionery.

Furthermore, in the case of the pound cake, the blending amount of the component (A) with respect to the moisture content, in the dough for a baked confectionery is preferably equal to or more than 0.01 and equal to or less than 0.24, in terms of a mass ratio, and from the viewpoint of improving the meltability in mouth, more preferably equal to or more than 0.03 and equal to or less than 0.14, still more preferably equal to or more than 0.05 and equal to or less than 0.1, and still further preferably equal to or more than 0.07 and equal to or less than 0.1. From the same viewpoints, in the case of the pound cake, the blending amount of the component (A) with respect to t e moisture content, in the dough for a baked confectionery is preferably equal to or more than 0.01, more preferably equal to or more than 0.03, still more preferably equal to or more than 0.05, and still further preferably equal to or more than 0.07, and is preferably equal to or less than 0.24, more preferably equal to or less than 0.14, and still more preferably equal to or less than 0.1, in terms of a mass ratio.

(Other Components)

In the present embodiment, the dough for a baked confectionery may contain a component other than the components described above as a raw material. As specific examples of the component other than the component other than the components described above, edible oils and fats or edible oils and fats compositions, such as margarine, shortening, butter, rapeseed oil, soybean oil, and olive oil, which are generally used for the dough for a baked confectionery; nuts; dried fruit; various flavor materials; and t like may be blended.

(Method for Producing Baked Confectionery)

Next, a production step for a baked confectionery will be described.

In the present embodiment, the production steps for the baked confectionery includes preparing the dough of a baked confectionery and heating the dough.

A method for preparing the dough of a baked confectionery may be a method commonly used, and examples thereof include a sugar batter method in which an oil or fat composition and sugar are added and kneaded, and eggs are gradually added so that the dough, does not separate, and then a powder (powder raw material) is added, thereto to prepare the dough, or an all-in-mix method in which all raw materials are added and mixed.

In addition, it is also possible to prepare the dough by using a mixed flour or the like, with the sugar batter method or the all in-mix method. Among them, in the production method that employs the all-in-mix method using, the mixed flour, it is possible to prepare the dough with a simple work step.

In addition, the prepared dough may be frozen and stored as a frozen dough.

The baked confectionery is obtainable through heating, the dough of baked confectionery prepared in this manner. Specific examples of a heating method include baking, steaming, steam convection heating, and frying. It is preferable to use one or two kinds of cooking selected from the baking and the frying, and it is more preferable to use the baking in an oven. A temperature of the cooking is preferably 150° C. to 230° C., and more preferably 160° C. to 220° C. The time is preferably 5 to 60 minutes, and more preferably 8 to 50 minutes.

The cooking conditions may be adjusted according to, for example, a kind of the baked confectionery and the components of the dough. The heating time may be, for example, equal to or longer than 30 seconds, or for example, equal to or shorter than 5 minutes.

(Dough of Baked Confectionery)

In the present embodiment, the dough of a baked confectionery includes the component (A), and has the moisture content (excluding moisture in the powder raw material) of equal to or more than 18% by mass and equal to or less than 55% by mass. The dough of a baked confectionery may be prepared by the method described above in the section (Method for producing baked confectionery).

(Baked Confectionery)

Examples of the baked confectionery obtainable in the present embodiment may include a pound cake, a sponge cake, a chiffon cake, a roll cake, a butter cake, Baumkuchen a muffin, a cupcake, a hot cake, Financier, busse, waffle, madeleine, pancake, corn dog, and whoopie pies, and are preferably one kind selected from the group consisting of the pound cake, the roll cake, the Baumkuchen, the sponge cake, and the chiffon cake, and more preferably one kind selected from the group consisting of the pound cake, the roll cake, the Baumkuchen, and the sponge cake. In addition, the baked confectionery is also preferably one selected from the group consisting of a pound cake, a roll cake, baumkuchen, the sponge cake, the pancake, the waffle, the corn dog, and the whoopie pie.

(Moisture Content of Baked Confectionery)

In the baked confectionery in the present embodiment, the moisture content of the baked confectionery is preferably equal to or more than 18% by mass and equal to or less than 45% by mass. The moisture content of the baked confectionery is the moisture content contained in the baked confectionery after baking, and is a value measured using a moisture meter or the like, by chopping the baked confectionery after baking. However, the moisture content of coating or toppings such as creams is not contained here. A measurement method of the moisture content of the baked confectionery will be described in the section of Examples.

Here, the sponge cake generally has the moisture content of about 30% by mass, and the butter cake represented by the pound cake has the moisture content of about 20% by mass. Therefore, the moisture content in the baked confectionery after baking is preferably equal to or more than 25% by mass and equal to or less than 40% by mass for the sponge cake, and preferably equal to or more than 21% by mass and equal to or less than 30% by mass for the pound cake. Furthermore, in the roll cake, the moisture content is preferably equal to or more than 30% by mass and equal to or less than 45% by mass.

Since the baked confectionery obtainable in the present embodiment contains the component (A) as an active ingredient and contains a predetermined amount of moisture, it is possible to improve the meltability in mouth of the baked confectionery.

In addition, in the present embodiment, the component (A) is blended in the dough for a baked confectionery, it is possible to effectively improve the meltability in mouth of the baked confectionery, by adjusting the moisture content in the dough and the water content in the dough for a baked confectionery to a predetermined amount.

### EXAMPLES

(Raw Materials)

In the following examples, the following raw materials were mainly used.

Soft flour: “Flour” manufactured by Nisshin Foods Inc.

Acid-treated starch: Acid-treated high-amylose corn starch produced in Production Example 1 to be described later

Granular product 1: Granular product produced by a method of Production Example 2 to be described later

Corn starch: “Corn starch Y”, manufactured by J-OIL MILLS, INC.

Oil or fat product 1 (Processed oil or fat): “Splendor L”, manufactured by J-OIL MILLS, INC. (moisture content of less than 1% by mass)

Oil or fat product 2 (Processed oil or fat): “Splendor HG”, manufactured by J-OIL MILLS, INC. (moisture content of less than 1% by mass)

Oil or fat product 3 (Processed oil or fat): “Meister Generta”, manufactured by J-OIL MILLS, INC. (moisture content of 18% by mass)

Oil or fat product 4 (Processed oil or fat): “Grand Master Switzar”, manufactured by J-OIL MILLS, INC. (moisture content of 15% by mass)

Oil or fat product 5: “Grand Master Primeran”, manufactured by J-OIL MILLS, INC. (moisture content of 17%)

Oil or fat product 6: Rapeseed oil, manufactured by J-OIL MILLS, INC. (moisture content of less than 1% by mass)

Egg: Whole egg (moisture content of 76.1% by mass)

Egg yolk (moisture content of 48.2% by mass)

Milk: “Makiba Umare no Gyunyu (Fresh Milk at Farm)” manufactured by Meiji Tokaisha (moisture content of 87.4% by mass)

Baking powder: “F-up”, manufactured b by Aikoku. Co., Ltd.

Sugar: “White sugar”, manufactured. by Mitsui Sugar Co. , Ltd.

Honey: “Funwari Renge Hachimitsu (Soft. Aetragalue honey)” manufactured by Kato Bihouen Honpo Co., Ltd. (moisture content of 17.6% by mass)

Skim. milk powder: “Skim milk powder”, Hokkaido Dairy Industry

(Production Example 1) Production of Acid-Treated Starch

Acid-treated starch was produced as a molecular weight-reduced starch as a raw material for a granular product 1.

(Method for Producing Acid-Treated High-Amylose Corn Starch)

High amylose corn starch (manufactured by J-OIL MILLS, INC., HS-7, and amylose content of 70% by mass) was suspended in water to prepare 35.6% (w/w) slurry, and was heated to 50° C. A reaction was started by adding an aqueous hydrochloric acid solution prepared to be 4.25 N in an amount of 1/9 times in terms of a mass ratio of the slurry while stirring. After reacting for 16 hours, it was neutralized with 3% NaOH, washed with water, dehydrated, and dried to obtain acid-treated high-amylose corn starch.

The peak molecular weight of the obtained acid-treated high-amylose corn starch was measured by a method to be described below, as a result, the peak molecular weight was 1.2×10⁴.

(Method for Measuring Peak Molecular Weight)

The peak molecular weight was measured using an HPLC unit manufactured by Tosoh Corporation (Pump DP-8020, RI detector RS-8021, and. Degassing device SD-8022).

(1) A sample was pulverized, and a fraction under a sieve having an opening of 0.15 mm was collected using a sieve of JIS-Z8801-1 standard. This collected fraction was suspended, in a mobile phase so as to be 1 mg/mL, and the suspension was heated at 100° C. for 3 minutes to completely dissolve. Filtration was performed using a 0.45 μm filtration filter (manufactured by ADVANTEC, DISMIC-25HP PTFE 0.45 μm), and a filtrate was used as an analytical sample.

(2) A molecular weight was measured under the following analysis conditions.

Column: Two columns of TS gel α-M (7.8 mmφ, 30 cm) (made by Tosoh Corporation)

Flow rate: 0.5 mL/min

Mobile phase: 5 rcpt NaNO₃-containing dimethyl sulfoxide solution at 90% (v/v)

Column temperature: 40° C.

Analytical volume: 0.2 mL

(3) The detector data was collected by software (multi-station GPC-8020 model II data collection ver 5.70, manufactured by Tosoh Corporation), and the molecular weight peak was calculated.

For a calibration curve, Pullulan with a known molecular weight (Shodex Standard P-82, manufactured by Showa Denko KK) was used.

(Method for Measuring Degree of Swelling in Cold Water)

(1) A sample was dried by heating at 125° C. using a moisture meter (model number MX-50, manufactured by Kensei Kogyo Co., Ltd.) to measure the moisture, and the mass of dry matter was calculated from a moisture value obtained.

(2) 1 g of the sample in terms of the mass of dry matter was in a state of being dispersed in 50 mL of water at 25° C., gently stirred in a constant temperature bath at 25° C. for 30 minutes, and then centrifuged at 3000 rpm for 10 minutes (Centrifuge: Hitachi desktop centrifuge CT6E type, manufactured by Hitachi Koki Co., Ltd.; Rotor: T4SS type swing rotor; and Adapter: 50TC×2S adapter), and separated into a sediment layer and a supernatant layer.

(3) The supernatant layer was removed, the mass of the sediment layer was measured, and this mass was set as B (g).

(4) The mass when the sediment layer was dried and solidified (105° C., constant weight) was set as C (g).

(5) A value obtained by dividing B by C was set as the degree of swelling cold water.

(Production Example 2) Production of Granular Product 1

79% by mass of corn starch, 20% by mass of acid-treated high-amylose corn starch obtained by the above method, and 1% by mass of calcium carbonate were mixed in a bag to be sufficiently uniform. A mixture was heat-treated under pressure using a twin-screw extruder (KEI-45 manufactured by Kowa Industry Co., Ltd. ). Processing conditions are as follows.

Raw material supply: 450 g/min

Water addition: 17% by mass

Barrel temperature: 50° C., 70° C., and 100° C. from the raw material inlet to the outlet

Outlet temperature: 100° C. to 110° C.

Screw rotation speed of 250 rpm

A heat-gelatinized product obtained by the extruder treatment in this manner was dried at 110° C. to adjust the moisture content to 10% by mass.

Next, the dried heat-gelatinized product was pulverized with a desktop cutter pulverizer and then sieved using a sieve of JIS-Z8801-1 standard. The sieved heat-gelatinized product was mixed at the following blending ratios to prepare the granular product 1. The degree of swelling of the granular product 1 in cold water was measured by the above method, as a result, was 7.3.

On a sieve having an opening of 0.5 mm: 0% by mass

Under a sieve with the opening of 0.5 mm, and on a sieve with an opening of 0.25 mm: 0% by mass

Under a sieve with the opening of 0.25 mm, and on a sieve with an opening of 0.15 mm: 36.4% by mass

Under a sieve with the opening of 0.15 mm, and on a sieve with an opening of 0.075 mm: 48.0% by mass

Under a sieve with the opening of 0.075 mm: 15.6% by mass

(Production Method of Sponge Cake)

A sponge cake was prepared by the all-in-mix method according to the following procedure.

1. Among the raw materials, the soft flour, the granular product 1 as the component (A), the sugar, and the baking powder were put in a plastic bag and mixed to prepare a mixed flour. In Control Example, the soft flour, the sugar, and the baking powder were put in a plastic bag and mixed. to obtain a mixed. flour.

2. Eggs (whole eggs), water, each of the oil or fat products, and the mixed flour obtained in above 1, was placed in a bowl and mixed with a hobart mixer equipped with a whisk at medium speed so that the specific gravity was 0.40 to 0.43.

As for the mixed dough, 280 g of the dough was put into a No. 6 round mold and baked in an oven under the following conditions.

Baking conditions: Upper part 180° C./Lower part 180° C.

Baking time: 27 minutes

(Method for Producing Pound Cake by Sugar Batter Method)

A pound cake was prepared by the sugar batter method according to the following procedure.

1. Among the raw materials, powder raw materials other than the sugar were put into a plastic bag, mixed, and sieved to prepare a mixed flour.

2. The oil or fat product 3 whose temperature was adjusted to 20° C, and the sugar were put into a bowl of a hobart mixer, and mixed at a medium speed using a beater. Then, the egg (whole egg) and water were mixed, and added in 10 portions, and mixed repeatedly to adjust the specific gravity to 0.65 to 0.67.

3. The above mixed flour was added and mixed at a low speed, and then mixed at a medium speed to prepare a dough for the pound cake having a dough specific gravity of 0.75 to 0.81.

4. The dough obtained in above 3, was put into a pastry bag, and 300 g each was put into a pound cake baking mold.

5. The pound mold was lightly dropped on a workbench plane t.o shape the dough.

6. The dough was baked in an oven under the following conditions to obtain a pound cake.

Baking temperature: Upper part 180° C./Lower part 180° C.

Baking time: 37 minutes

(Method for Producing Pound Cake by Method)

A pound cake was prepared by the all-in-mix method according following procedure.

1. Among the raw materials, powder raw materials other than the sugar were put into a plastic bag, mixed, and sieved to prepare a mixed flour.

2. The oil or fat product 1 and the oil or fat product 3 whose temperatures were adjusted to 20° C., the sugar, and the whole egg were put into a bowl of a hobart mixer together with the mixed flour, mixed at low speed using a beater, and then mixed at, a medium speed to prepare a dough so that the final dough specific gravity was 0.75 to 0.81.

3. The dough obtained in above 2, was put into a pastry bag, and 300 g each was put into a pound cake baking mold.

4. The pound mold was lightly dropped on a workbench plane to shape the dough.

5. The dough was baked in an oven under the following conditions to obtain a pound cake.

Baking temperature: Upper part 180° C./Lower part 180° C.

Baking time: 37 minutes

(Measurement Method of Moisture Content After Baking)

The baked confectionery after baking was chopped, and 1 g of the chopped baked confectionery was dried by heating at 130° C. with a moisture meter (Kensei Kogyo Co., Ltd., model number MX-50) to measure the moisture.

(Evaluation Method)

In the following, the baked confectionery prepared in each example was evaluated for water removal, a moist feeling, meltability in mouth, and ease of swallowing by the consensus of three specialized panelists. A score of equal to or higher than 4 was set as a pass. Evaluation criteria are shown below.

(Water Removal)

5: No watery layer is seen on a dough after baking

4: Almost no watery layer is seen on a dough after baking

3: Only a few watery layer is seen on a dough after baking

2: A slight watery layer is seen on a dough after baking

1: A considerable watery layer can be seen on a dough after baking

(Moist Feeling)

5: Very moist

4. Moist

3: Feel few dryness

2: Feel slightly dryness

1: Feel considerable dryness

(Feeling of Meltability in Mouth)

5: Time to disappear in a mouth is very short

4: Time to disappear in a mouth is short

3: Time to disappear in a mouth is slightly long

2: Time to disappear in a mouth is long

Time to disappear in a mouth. is very long

(Ease of Swallowing)

5: A. dough is not lumpy in a mouth and is very easy to swallow

4: A. dough is almost not lumpy in a mouth, and is easy to swallow

3: A dough is a little lumpy in a mouth and is a little hard to swallow

2: A dough is slightly lumpy in a mouth, and is slightly hard to swallow

1: A dough is very lumpy in a mouth and is very hard to swallow

(Experiment 1)

A dough was prepared using the raw materials shown in Table 1 by the method described above and baked to prepare a sponge cake, which was evaluated. Also, in Comparative Example 1-2, the component (A) was replaced with a starch mixture (degree of swelling in cold water: 2.6) in which the acid-treated starch, which is raw material starch of the component (A) and is obtained in Production Example 1, and corn starch were mixed at a ratio of 1: 9, and a sponge cake was prepared and evaluated.

Evaluation results are shown in Table 1.

TABLE 1

| | | Control | Comparative | Comparative | Example | Example |
|---|---|---|---|---|---|---|
| Raw material (part(s) by mass) | | Example 1 | Example 1-1 | Example 1-2 | 1-1 | 1-2 |
| Powder | Soft flour | 100 | 100 | 90 | 90 | 90 |
| raw | Granular product 1 | | | | 10 | 10 |
| material | Starch mixture | | | 10 | | |
| | Sugar | 100 | 100 | 100 | 100 | 100 |
| | Baking powder | 2 | 2 | 2 | 2 | 2 |
| Other raw | Water | 0 | 30 | 30 | 0 | 30 |
| materials | Egg | 150 | 150 | 150 | 150 | 150 |
| | Oil or fat product 1 | 40 | 40 | 40 | 40 | 40 |
| | Oil or fat product 2 | 15 | 15 | 15 | 15 | 15 |
| Total (part(s) by mass) | | 407 | 437 | 437 | 407 | 437 |
| | Component (A)/Powder raw | 0 | 0 | 0 | 4.95 | 4.95 |
| | material (% by mass) * | | | | | |
| | Moisture content/Dough | 28.0 | 33.0 | 33.0 | 26.0 | 33.0 |
| | (% by mass) ** | | | | | |
| | Component (A)/Moisture | | | | | |
| | content in dough (Mass ratio) | — | — | — | 0.088 | 0.069 |
| | *** | | | | | |
| | Moisture content after | | | | | |
| | baking (% by mass) | 27.5 | — | — | 27.3 | 33.1 |
| Evaluation | Water removal | 5 | 5 | 5 | 5 | 5 |
| item | Moist feeling | 2 | 3 | 2 | 4 | 5 |
| | Meltability in mouth | 3 | 3 | 2 | 4 | 5 |
| | Ease of swallowing | 3 | 2 | 3 | 4 | 5 |
| | | Example | Example | Example | Comparative | Example |
| Raw material (part(s) by mass) | | 1-3 | 1-4 | 1-5 | Example 1-3 | 1-6 |
| Powder | Soft flour | 90 | 90 | 90 | 100 | 90 |
| raw | Granular product 1 | 10 | 10 | 10 | | 10 |
| material | Starch mixture | | | | | |
| | Sugar | 100 | 100 | 100 | 100 | 100 |
| | Baking powder | 2 | 2 | 2 | 2 | 2 |
| Other raw | Water | 35 | 40 | 50 | 60 | 60 |
| materials | Egg | 150 | 150 | 150 | 150 | 150 |
| | Oil or fat product 1 | 40 | 40 | 40 | 40 | 40 |
| | Oil or fat product 2 | 15 | 15 | 15 | 15 | 15 |
| Total (part(s) by mass) | | 442 | 447 | 457 | 467 | 467 |
| | Component (A)/Powder raw | 4.95 | 4.95 | 4.95 | 0 | 4.95 |
| | material (% by mass) * | | | | | |
| | Moisture content/Dough | 33.7 | 34.5 | 35.9 | 37.3 | 37.3 |
| | (% by mass) ** | | | | | |
| | Component (A)/Moisture | | | | | |
| | content in dough (Mass ratio) | 0.067 | 0.065 | 0.061 | — | 0.057 |
| | *** | | | | | |
| | Moisture content after | | | | | |
| | baking (% by mass) | 34.8 | 34.8 | 35.5 | — | — |
| Evaluation | Water removal | 5 | 5 | 5 | 4 | 4 |
| item | Moist feeling | 5 | 5 | 5 | 3 | 4 |
| | Meltability in mouth | 5 | 5 | 5 | 1 | 4 |
| | Ease of swallowing | 5 | 5 | 5 | 2 | 4 |

Note)
* Component (A)/Powder raw material (% by mass) refers to the mass (% by mass) of the component (A) to the powder raw materials.
** Moisture content/Dough (% by mass) refers to the mass (% by mass) of the moisture content (excluding moisture contained in the powder raw material) to the entirety of the dough.
*** Component (A)/Moisture content in dough (Mass ratio) refers to a mass ratio of the component (A) to the moisture content (excluding moisture contained in the powder raw material) in the dough.

In the next of Table 1 and Table 2 to be described later, the “moisture content to the entirety of the dough” described in Note ** and the “moisture content in the dough” described in Note *** have the same meaning.

Further, in Table 1 and Table 2 and the subsequent tables to be described later, the “moisture content after baking” is the moisture content of the baked confectionery described above.

Moreover, in Table 1 and Table 2 and the subsequent tables to be described later, “egg” is a whole egg unless otherwise specified.

From Table 1, in terms of a moist feeling improvement in meltability in mouth, and ease of swallowing in a sponge cake, it was good when the moisture content/dough is e to or more than 28.0% by mass and equal to or less than 37.3% by mass, and it was even better when the moisture content/dough was equal to or more than 33.0% by mass and equal to or less than 35.9% by mass.

Further, in terms of the moist feeling, improvement in the meltability in mouth, and the ease of swallowing in the sponge cake, it was good when the component (A)/moisture content in dough is equal to or more than 0.057 and equal to or less than 0.088, and it was even better when the component (A)/moisture content in the dough was equal to or more than 0.061 and equal to or less than 0.069.

On the other hand, in a case where although the moisture content/dough was the same as in Example 1-1, the component (A) was not contained, as in Control Example 1, the moist feeling was inferior.

In addition, in a case where water was added without containing the component (A) as in Comparative Example 1-1, it was hard to swallow due to being lumpy. As shown in Comparative Example 1-2, when the raw material starch mixture of the component (A) (the degree of swelling in cold water does not meet the predetermined range) was added to adjust the moisture content, it. was inferior to Example 1-2, in terms of the moist feeling, the improvement. in the meltability in mouth, and the ease of swallowing.

(Experiment 2)

A dough was prepared by the sugar batter method described above with blending ratios of the raw materials shown in Table 2, and baked to prepare a pound cake, which was evaluated.

Each of evaluation results is shown in Table 2.

TABLE 2

| | | Control | Example | Example |
|---|---|---|---|---|
| Raw material (part (s) by mass) | | Example 2 | 2-1 | 2-2 |
| Powder | Soft flour | 100 | 97 | 90 |
| raw | Granular product 1 | | 3 | 10 |
| material | Sugar | 90 | 90 | 90 |
| | Baking powder | 1.5 | 1.8 | 1.5 |
| Other raw | Water | | 9 | 30 |
| materials | Egg | 100 | 100 | 100 |
| | Oil or fat product 3 | 80 | 80 | 80 |
| Total (part (s) by mass) | | 371.5 | 380.5 | 402,18 |
| | Component (A)/ | 0 | 1.57 | 5.22 |
| | Powder raw material | | | |
| | (% by mass) * | | | |
| | Moisture content/ | 24.4 | 26.1 | 30.0 |
| | Dough (% bymass) ** | | | |
| | Component (A/ | — | 0.030 | 0.083 |
| | Moisture content in | | | |
| | dough (Mass ratio) *** | | | |
| Evaluation | Water removal | 5 | 5 | 5 |
| item | Moist feeling | 3 | 5 | 5 |
| | Meltability in mouth | 3 | 4 | 5 |
| | Ease of swallowing | 3 | 5 | 5 |

Note)
* Component (A)/Powder raw material (% by mass) refers to the mass (% by mass) of the component (A) to the powder raw materials.
** Moisture content/Dough (% by mass) refers to the mass (% by mass) of the moisture content (excluding moisture contained in the powder raw material) to the entirety of the dough.
*** Component (A)/Moisture content in dough (Mass ratio) refers to a mass ratio of the component (A) to the moisture content (excluding moisture contained in the powder raw material) in the dough.

From Table 2, in the pound cake prepared by the sugar patter method, it was good when the component (A)/powder raw material was equal to or more than 1.57% by mass and equal to or less than 5.22% by mass, from the viewpoint of improving the meltability in mouth.

In addition, it was good when the moisture content/dough was equal to or more than 26.1% by mass and equal to or less than 30.0% by mass, from the viewpoint of improving the meltability in mouth.

In addition, it was good when the component (A)/moisture content in the dough was equal to or more than 0.030 and equal to or less than 0.083, from the viewpoint of improving the meltability in mouth.

(Experiment 3)

A dough was prepared by the all-in-mix method described above by changing the moisture content with the blending ratios of the raw materials shown in Table 3, and baked to prepare a pound cake, which was evaluated.

TABLE 3

| | | Example | Example |
|---|---|---|---|
| Raw material (part (s) by mass) | | 3-1 | 3-2 |
| Powder | Soft flour | 90 | 90 |
| raw | Granular product 1 | 10 | 10 |
| material | Sugar | 90 | 90 |
| | Baking powder | 1.5 | 1.5 |
| Other raw | Water | 40 | 50 |
| materials | Egg | 100 | 100 |
| | Oil or fat product 3 | 50 | 50 |
| | Oil or fat product 1 | 30 | 30 |
| Total (part (s) by mass) | | 411.5 | 421.5 |
| | Component (A)/ | 5.22 | 5.22 |
| | Powder raw material | | |
| | (% by mass) * | | |
| | Moisture content/ | 30.4 | 32.1 |
| | Dough (% by mass) ** | | |
| | Component (A)/ | 0.080 | 0.074 |
| | Moisture content | | |
| | in dough | | |
| | (Mass ratio) *** | | |
| | Moisture content | Not | 32.0 |
| | after baking | measured | |
| | (% by mass) | | |
| Evaluation | Water removal | 4 | 4 |
| item | Moist feeling | 5 | 5 |
| | Meltability in mouth | 5 | 5 |
| | Ease of swallowing | 4 | 4 |

Note)
* Component (A)/Powder raw material (% by mass) refers to the mass (% by mass) of the component (A) to the powder raw materials.
** Moisture content/Dough (% by mass) refers to the mass (% by mass) of the moisture content (excluding moisture contained in the powder raw material) to the entirety of the dough.
*** Component (A)/Moisture content in dough (Mass ratio) refers to a mass ratio of the component (A) to the moisture content (excluding moisture contained in the powder raw material) in the dough.

In the pound cake prepared by the all-in-mix method, a preferable pound cake was obtained as in the sugar batter method.

In terms of the moist feeling and improvement in the meltability in mouth, it was good when the moisture content/dough was equal to or more than 30.4% by mass and equal to or less than 32.1% by mass. It was good when the component (A)/moisture content in the dough was equal to or more than 0.074 and equal to or less than 0.080.

(Experiment 4)

A dough was prepared by the method described above at the blending ratios of the raw materials described in Table 4, and baked to prepare a sponge cake, which was evaluated. In Example 4-2, milk was used instead of the water.

Evaluation results are shown in Table 4.

TABLE 4

| Raw material | | Example | Example | Example |
|---|---|---|---|---|
| (part (s) by mass) | | 4-1 | 4-2 | 4-3 |
| Powder | Soft flour | 90 | 90 | 90 |
| raw | Granular product 1 | 10 | 10 | 10 |
| material | Sugar | 100 | 100 | 100 |
| | Baking powder | 2 | 2 | 2 |
| Other | Water | 35 | | |
| raw materials | Milk | | 35 | |
| | Egg | 150 | 150 | 185 |
| | Oil or fat product 1 | 40 | 40 | 40 |
| | Oil or fat product 2 | 15 | 15 | 15 |
| Total (part (s) by mass) | | 442 | 442 | 442 |
| | Component (A)/ | 4.95 | 4.95 | 4.95 |
| | Powder raw material | | | |
| | (% by mass) * | | | |
| | Moisture content/ | 33.7 | 32.7 | 31.9 |
| | Dough (% | | | |
| | by mass) ** | | | |
| | Component (A)/ | 0.067 | 0.069 | 0.071 |
| | Moisture content | | | |
| | in dough | | | |
| | (Mass ratio) *** | | | |
| | Moisture content | 35.7 | 33.4 | 33.7 |
| | after baking | | | |
| | (% by mass) | | | |
| Evaluation | Water removal | 5 | 5 | 5 |
| item | Moist feeling | 5 | 5 | 4 |
| | Meltability in mouth | 5 | 4 | 4 |
| | Ease of swallowing | 5 | 4 | 4 |

Note)
* Component (A)/Powder raw material (% by mass) refers to the mass (% by mass) of the component (A) to the powder raw materials.
** Moisture content/Dough (% by mass) refers to the mass (% by mass) of the moisture content (excluding moisture contained in the powder raw material) to the entirety of the dough.
*** Component (A)/Moisture content in dough (Mass ratio) refers to a mass ratio of the component (A) to the moisture content (excluding moisture contained in the powder raw material) in the dough.

Even when using the milk instead of the water, a sponge cake with preferable meltability in mouth could be prepared. Further, although the sponge cake could be prepared with the moisture of the egg, the sponge cake of Example 4-1 to which the water was added was the best in terms of improvement in the meltability in mouth and the ease of swallowing, followed by the sponge cakes using the milk of Example 4-2 and using the egg of Example 4-3 were good. Also, in terms of the moist feeling, the sponge cakes to which the water and the milk were added was the best.

(Example of Coating of Caked Confectionery)

The sponge cake obtained in Example 1-3 was coated with whipped cream to obtain a decoration cake. This decoration cake had very good meltability in mouth, which was preferable.

(Experiment 5)

In Experiment 5, a cream roll cake was prepared. First, a dough was prepared by the method below at the blending ratios of the raw materials described in Table 5, and baked to prepare a sponge cake for a roll cake. Next, fresh cream was decorated by a method described below to prepare the cream roll cake, which was evaluated by the same method as described above.

Evaluation results are shown in Table 5.

(Method for Producing Sponge Cake for Roll Cake)

1. Among the raw materials, the soft flour, the granular product 1 as the component (A), the sugar, and the baking powder were put in a plastic bag and mixed to prepare a mixed flour. In Control Example, the soft flour, the sugar, and the baking powder were put in a plastic bag and mixed to obtain a mixed flour.

2. Whole eggs, each oil or fat. product, other raw materials, and the mixed flour obtained in above 1, was placed in a bowl and mixed with a hobart mixer equipped with a whisk at medium speed so that the specific gravity was 0.32 to 0.36.

3. 550 g of a dough after mixed was placed on a baking tray split into 8 (dimensions: 350×400 mm) and baked in an oven under the following conditions.

Baking conditions: Upper part 180° C./Lower part 180° C.

Baking time: 12 minutes

(Decoration Method for Roll Cake)

In Examples 5-1 and 5-2 and Control Example 3, whipped cream was prepared by the following method and squeezed to obtain a cream roll cake of each example.

1. One pack of fresh cream was placed in a bowl, 16 g of white sugar was added, and the mixture was whipped at medium speed with a mixer to obtain an 80% stiff whipped cream.

2. The whipped cream was evenly applied to the sponge cake of each example after baking with a palette knife to have a thickness of 5 to 6 mm.

3. A surface of the sponge cake coated with the cream in above was rolled inward and formed into a tubular state to obtain the cream roll cake.

4. The obtained cake was eaten and evaluated.

TABLE 5

| Raw material | | Control | Example | Example |
|---|---|---|---|---|
| (part (s) by mass) | | Example 3 | 5-1 | 5-2 |
| Powder | Soft flour | 80 | 60 | 60 |
| raw | Granular product 1 | | 20 | 20 |
| material | White Sugar | 60 | 60 | 90 |
| | Baking powder | 1.5 | 1.5 | 1.5 |
| Other raw | Water | 60 | 60 | 60 |
| materials | Whole egg | 240 | 240 | 240 |
| | Egg yolk | 40 | 40 | 40 |
| | Honey | 30 | 30 | |
| | Oil or fat product 1 | 50 | 50 | 50 |
| | Oil or fat product 2 | 30 | 30 | 30 |
| Total (part (s) by mass) | | 591.5 | 591.5 | 591.5 |
| | Component (A)/ | 0.0 | 14.13 | 11.66 |
| | Powder raw material | | | |
| | (% by mass) * | | | |
| | Moisture content/ | 45.2 | 45.2 | 44.3 |
| | Dough (% | | | |
| | by mass) ** | | | |
| | Component (A)/ | — | 0.075 | 0.076 |
| | Moisture content | | | |
| | in dough | | | |
| | (Mass ratio) *** | | | |
| | Moisture content | 35.7 | 40.1 | 38.7 |
| | after baking | | | |
| | (% by mass) | | | |
| Evaluation item | | | | |
| | Water removal | 3 | 4 | 4 |
| | Moist feeling | 3 | 5 | 4 |
| | Meltability in mouth | 3 | 4 | 4 |
| | Ease of swallowing | 3 | 4 | 4 |

Note)
* Component (A)/Powder raw material (% by mass) refers to the mass (% by mass) of the component (A) to the powder raw materials.
** Moisture content/Dough (% by mass) refers to the mass (% by mass) of the moisture content (excluding moisture contained in the powder raw material) to the entirety of the dough.
*** Component (A)/Moisture content in dough (Mass ratio) refers to a mass ratio of the component (A) to the moisture content (excluding moisture contained in the powder raw material) in the dough.

From Table 5, in a case where the component (A) and a predetermined amount of moisture were contained, a roll cake with improved meltability in mouth could be prepared.

When the mass (moisture content/dough (% by mass)) of the moisture content (excluding the moisture contained in the powder raw material) with respect to the entirety of the dough is equal to or more than 44.3% by mass and equal to or less than 45.2% by mass, the water removal was good and the moist feeling, the meltability in mouth, and the ease of swallowing were excellent, and when the mass was 45.2% by mass, the moist feeling was further excellent.

In addition, the mass ratio (component (A)/moisture content in the dough (mass ratio)) of the component (A) to the moisture content (excluding the moisture contained in the powder raw material) in the dough is equal to or more than 0.075 and equal to or less than 0.076, the water removal, was good and the moist feeling, the meltability in mouth, and the ease of swallowing were excellent.

(Example of Decoration for Roll Cake)

A sponge cake was prepared according to the procedure of Experiment 5. The sponge cake was cut into 22 cm in length and 2.2 cm in width, and placed inside a paper cupcake mold (size: bottom diameter 75×height 22.5 mm) in a circular motion, and 25 g of whipped cream obtained by the same method as in Experiment 5 was squeezed out to an open portion at the center to obtain a roll cake. This roll cake was very moist, had excellent meltability in mouth, and was easy to swallow and thus was preferable.

(Experiment 6)

In Experiment 6, Baumkuchen was prepared. A dough was prepared by the method below at the blending ratios of the raw materials described in Table 6, and baked to prepare Baumkuchen.

(Method for Producing Baumkuchen)

1. Among the raw materials, the soft flour, the granular product 1 as the component. (A), the sugar, and the baking powder were put in a plastic bag and mixed to prepare a mixed flour.

2. The oil or fat product 1, the oil or fat product 2, the water, the whole eggs, and the mixed flour obtained in above 1, was placed in a bowl and mixed with Kanto 20-quart mixer equipped with a whisk at medium speed so that the specific gravity was 0.42 to 0.46 to obtain a mixture.

3. The melted oil or fat product 4 was added to the mixture of above 2, and mixed to obtain a dough for Baumkuchen.

4. The dough obtained in above 3, was baked in a Baumkuchen oven (KJ-F04, manufactured by Kajiki Sangyo Co. Ltd.) under the following conditions.

Baking conditions: Internal temperature of 260° C., time for dough roll of 14 seconds

Baking time: 65 seconds per roll×15 rolls

5. After baking, the Baumkuchen was cooled down, wrapped in a plastic wrap, left overnight, and then eaten and evaluated.

TABLE 6

| Raw material | | |
|---|---|---|
| (part (s) by mass) | | Example 6-1 |
| Powder | Soft flour | 800 |
| raw | Granular product 1 | 200 |
| material | White Sugar | 1000 |
| | Baking powder | 10.0 |
| Other | Water | 400 |
| raw | Whole egg | 1600 |
| materials | Oil or fat product 1 | 200 |
| | Oil or fat ploduct 2 | 150 |
| | Oil or fat product 4 | 650 |
| Total (part(s) by mass) | | 5010 |
| | Component (A)/ | 9.95 |
| | Powder raw material | |
| | (% by mass) * | |
| | Moisture content/ | 34.2 |
| | Dough (% by mass) ** | |
| | Component (A)/ | 0.117 |
| | Moisture content | |
| | in dough | |
| | (Mass ratio) *** | |
| | Moisture content | 25.1 |
| | after baking | |
| | (% by mass) | |

Note)
* Component (A)/Powder raw material (% by mass) refers to the mass (% by mass) of the component (A) to the powder raw materials.
** Moisture content/Dough (% by mass) refers to the mass (% by mass) of the moisture content (excluding moisture contained in the powder raw material) to the entirety of the dough.
*** Component (A)/Moisture content in dough (Mass ratio) refers to a mass ratio of the component (A) to the moisture content (excluding moisture contained in the powder raw material) in the dough.

When the Baumkuchen Example 6-1 was eaten, since the granular product 1 and a predetermined moisture were contained, it was moist, had excellent meltability in mouth, and was easy to swallow and thus was preferable.

(Experiment 7)

In Experiment 7, a pancake was prepared. Dough was prepared by the method below at the blending ratios of the raw materials described in Table 7, and baked to prepare the pancake.

(Method for Producing Pancake)

A pancake was prepared by the following procedure.

1. The oil or fat product 2, the whole eggs, the milk, the white sugar, and the water were placed in a bowl and stirred uniformly with a hobart mixer equipped with a whisk until the specific gravity reached 0.25 to 0.28.

2. The granular product 1, the soft flour, and the baking powder were added to above 1, and mixed uniformly. In the control example, the soft flour and the baking powder were added and mixed uniformly.

3. The oil or fat product 5 which was heated and dissolved 50° C. was added to above 2, and mixed uniformly to obtain a dough for the pancake.

4. 55 g of the dough obtained in above 3, was baked on a hot plate using a cercle (ring mold) having a diameter of 10 cm under the following conditions.

Baking temperature: 170° C.

Baking time: 6 minutes on one side, 3 minutes by turning over 5. After completely cooled, it was used for evaluation.

(Evaluation Method)

In the following, the pancake prepared in each example was evaluated for the water removal, the moist feeling, the meltability in mouth, and the ease of swallowing by three specialized panelists, and an average value thereof was calculated. A score of higher than 3 was set as a pass. Evaluation criteria are shown below. The evaluation results are shown in Table 7.

(Water Removal)

5: No watery layer is seen on a dough after baking

4: Almost no watery layer is seen on a dough after baking

3: Only a few watery layer is seen on a dough after baking

2: A slight watery layer is seen on a dough after baking

1: A considerable watery layer can be seen on a dough after baking

(Moist Feeling)

5: Very moist

4: Moist

3: Feel few dryness

2: Feel slightly dryness

1: Feel considerable dryness

(Feeling of Meltability in Mouth)

5: Time to disappear in a mouth is very short

4: Time to disappear in a mouth is short

3: Time to disappear in a mouth is slightly long

2: Time to disappear in a mouth is long

1: Time to disappear in a mouth is very long

(Ease of Swallowing)

5: A dough is riot lumpy in a mouth and is very easy to swallow

4 : A dough is almost not lumpy in a mouth and is easy to swallow

3: A dough is a little lumpy in a mouth and is a little hard to swallow

2: A dough is slightly lumpy in a mouth, and is slightly hard to swallow

1: A dough is very lumpy in a mouth and is very hard to swallow

TABLE 7

| | | Control | | | | |
|---|---|---|---|---|---|---|
| Raw material (part(s) by mass) | | Example 4 | Example 7-1 | Example 7-2 | Example 7-3 | Example 7-4 |
| Powder raw | Soft flour | 100 | 80 | 90 | 90 | 90 |
| material | Granular product 1 | | 20 | 10 | 10 | 10 |
| | White Sugar | 50 | 50 | 50 | 50 | 50 |
| | Baking powder | 5 | 5 | 5 | 5 | 5 |
| Moisture | Water | 30 | 60 | 35 | 45 | 50 |
| | Milk | 30 | 30 | 30 | 30 | 30 |
| | Whole egg | 120 | 120 | 120 | 120 | 120 |
| Others | Oil or fat product 5 | 30 | 30 | 30 | 30 | 30 |
| | Oil or fat product 2 | 15 | 15 | 15 | 15 | 15 |

| | | | | | |
|---|---|---|---|---|---|
| Total (part(s) by mass) | 380 | 410 | 385 | 395 | 400 |
| Component (A)/Powder raw material (% | 0.0 | 12.90 | 6.45 | 6.45 | 6.45 |
| by mass) * | | | | | |
| Moisture content/Dough (% by mass) ** | 38.8 | 43.3 | 39.6 | 41.1 | 41.9 |
| Component (A) /Moisture content in | 0,0 | 0.113 | 0.066 | 0.062 | 0.060 |
| dough (Mass ratio) *** | | | | | |
| Moisture content after baking (% by | — | 397 | — | — | — |
| mass) | | | | | |
| Evaluation item | | | | | |
| Water removal | 5.0 | 5.0 | 5.0 | 5.0 | 5.0 |
| Moist feeling | 1.0 | 4.7 | 4.0 | 4,0 | 4.0 |
| Meltability in mouth | 2.0 | 4.7 | 4.0 | 4.3 | 4.3 |
| Ease of swallowing | 2.0 | 4.3 | 3.7 | 4.3 | 4.3 |

In Table 7, and Table 8 and next tables to be described later, “*” to “*** ” are the same as the notes “*” t o “***” described at the lower part of Table 1, respectively.

Also, in Table 7, and Table 8 and next tables to be described later, “−” in the section of “Moisture content of baked confectionery” indicates that the measurement was not performed.

From Table 7, the pancake obtained in each example had a better balance of the water removal, the moist feeling, the meltability in mouth, and the ease of swallowing, than the pancake of Control Example 4.

(Experiment 8)

In Experiment 8, a waffle was prepared. A dough was prepared by the method below at the blending ratios of the raw materials described in Table 8, and baked to prepare the waffle.

(Method for Producing Waffle)

1. White sugar, honey, whole eggs, milk, and the oil or fat product 2 were mixed using a whisk until the specific gravity was about 0.25 to 0.28.

2. The soft flour, the granular product, and the baking powder were added to above 1, and then the melted oil or fat product 5 was added and mixed to obtain a dough haling a final dough specific gravity of about 0.38 to 0.41. In the control example, the dough was obtained by the same procedure except that the granular product and water were not added.

3. This dough was baked in a waffle machine for about 1 minute and 45 seconds to obtain the waffle.

The waffle was completely cooled, and then eaten and evaluated.

TABLE 8

| | | Control | |
|---|---|---|---|
| Raw material (part (s) by mass) | | Example 5 | Example 8 |
| Powder | Soft flour | 100 | 80 |
| raw | Granular product 1 | | 20 |
| material | White Sugar | 60 | 60 |
| | Baking powder | 1 | 1 |
| Moisture | Water | 40 | |
| | Milk | 30 | 30 |
| | Honey | 20 | 20 |
| | Whole egg | 160 | 160 |
| Others | Oil or fat product 5 | 20 | 20 |
| | Oil or fat product 2 | 15 | 15 |

| | | |
|---|---|---|
| Total (part (s) by mass) | 406 | 446 |
| Component (A)/ | 0.0 | 12.42 |
| Powder raw material | | |
| (% by mass) * | | |
| Moisture content/ | 38.2 | 43.7 |
| Dough (% by mass) ** | | |
| Component (A)/ | 0.0 | 0.103 |
| Moisture content | | |
| in dough (Mass ratio) *** | | |
| Moisture content | — | — |
| after baking (% by mass) | | |

The waffled obtained in Example 8 had better meltability in mouth, a moist feeling, and a good texture as compared with the waffle of Control Example 5.

(Experiment 9)

In Experiment 9, a corn dog was prepared. A dough was prepared by the method below at the blending ratios of the raw materials described in Table 9, and baked to prepare the corn dog.

(Method for Producing Corn Dog)

1. The soft flour, the granular product, the baking powder, and the white sugar were well mixed to prepare a mixed flour. In the control example, the soft flour, the baking powder, and the white sugar were well mixed to prepare a mixed flour.

2. The whole egg, the milk, the honey, and the water were added to the mixed flour obtained in above 1, and mixed, and the oil or fat product 6 (rapeseed oil) was further mixed to obtain a batter solution. In the control example, the batter solution was obtained by the same procedure as in the example except that water was not added.

3. A sausage was sprinkled with the soft flour, soaked in a batter solution, and oiled at 175° C. for 4 minutes to obtain the corn dog.

TABLE 9

| | | Control | |
|---|---|---|---|
| Raw material (part (s) by mass) | | Example 5 | Example 8 |
| Powder | Soft flour | 100 | 80 |
| raw | Granular product 1 | | 20 |
| material | White Sugar | 60 | 60 |
| | Baking powder | 1 | 1 |
| Moisture | Water | | 40 |
| | Milk | 30 | 30 |
| | Honey | 20 | 20 |
| | Whole egg | 160 | 160 |
| Others | Oil or fat product 6 | 20 | 20 |

| | | |
|---|---|---|
| Total (part (s) by mass) | 391 | 431 |
| Component (A)/ | 0.0 | 12.42 |
| Powder raw material | | |
| (% by mass) * | | |
| Moisture content/ | 38.7 | 44.4 |
| Dough (% by mass) ** | | |
| Component (A)/ | 0.0 | 0.104 |
| Moisture content | | |
| in dough (Mass ratio) *** | | |
| Moisture content | — | — |
| after baking (% by mass) | | |

The corn dog obtained in Example 9 was a soft, and had the moist feeling, and a good texture that melted well in a mouth as compared with the corn dog of Control Example 6.

(Experiment 10)

In Experiment 10, a whoopie pie was prepared. A dough was prepared by the method below at the blending ratios of the raw materials described in Table 10, and baked to prepare the whoopie pie. The obtained whoopie pie was evaluated according to the pancake evaluation method.

(Method for Producing Whoopie Pie)

1. Among the raw materials, the soft flour, the granular product 1 as the component (A), the white sugar, the skim milk powder, and baking powder were put in a plastic bag and mixed to prepare a mixed flour. In Control Example, the soft flour, the white sugar, the skim milk powder and the baking powder were put in a plastic bag and mixed to obtain a mixed flour.

2. Water, milk, whole eggs, egg yolks, each of the oil or fat products, and the mixed flour obtained in above 1 were placed in a bowl and mixed with a hobart mixer equipped with a whisk at medium speed so that the specific gravity was about 0.7.

550 g of a dough after mixed. was squeezed out on a baking sheet by 25 g with a pastry hag and baked in an oven under the following conditions.

Baking conditions: Upper part 180° C./Lower part 180° C.

Baking time: 15 minutes

4. After the baked dough is completely cooled, each 3 g of syrup (obtained by mixing 300 g of water, 300 g of granulated sugar, and 15 g of cognac and heating the mixture to remove alcohol and cooling the mixture) is beaten, and each 15 g of butter cream (obtained by mixing 500 g of BC shortening (manufactured by J-OIL MILLS, INC.), 250 g of powdered sugar, 25 g of skim milk powder, and 0.3 g of vanilla flavor (manufactured by Golden Kelly Pat. Flavor co., ltd.) by a hobart mixer so that the specific gravity is around 0.8) was sandwiched.

TABLE 10

| | | Control | Example |
|---|---|---|---|
| Raw material (part (s) by mass) | | Example 7 | 10 |
| Powder | Soft flour | 150 | 131 |
| raw | Granular product 1 | | 19 |
| material | White Sugar | 50 | 50 |
| | Skim milk powder | 10 | 10 |
| | Baking powder | 5 | 5 |
| Moisture | Water | 40 | 70 |
| | Milk | 20 | 20 |
| | Whole egg | 60 | 60 |
| | Egg yolk | 10 | 10 |
| Others | Oil or fat product 2 | 12 | 12 |
| | Oil or fat product 5 | 40 | 40 |

| | | |
|---|---|---|
| Total (part (s) by mass) | 397 | 425 |
| Component (A)/ | 0.0 | 8.8 |
| Powder raw material | | |
| (% by mass) * | | |
| Moisture content/ | 28.9 | 34.1 |
| Dough (% by mass) ** | | |
| Component (A)/ | 0.0 | 0.131 |
| Moisture content | | |
| in dough (Mass ratio) *** | | |
| Moisture content | 19.52 | 20.66 |
| after baking (% by mass) | | |
| Evaluation item | | |
| Water removal | 3.0 | 4.0 |
| Moist feeling | 3.0 | 5.0 |
| Meltability in mouth | 3.0 | 4.0 |
| Ease of swallowing | 3.0 | 5.0 |

The whoopie pie obtained in example was a soft, and had the moist feeling, and a good texture that melted well in a mouth as compared with the whoopie pie of control example. Above all, it was excellent in terms of the moist feeling and the ease of swallowing.

Priority is claimed on Japanese Patent application No. 2018-147254, filed on Aug. 3, 2018, and Japanese Patent Application No. 2018-197980, filed on Oct. 19, 2018, the entire disclosures of which are incorporated herein.

1. A method for producing a baked confectionery, the method comprising:
preparing a dough of a baked confectionery, containing a component (A) below and having a moisture content (excluding moisture in a powder raw material) of equal to or more than 18% by mass and equal to or less than 55% by mass; and
heating the dough,
wherein in the preparing the dough of a baked confectionery, a blending amount of the component (A) with respect to the moisture content is equal to or more than 0.01 and equal to or less than 0.24, in terms of a mass ratio, and
the component (A) is a granular product containing equal to or more than 75% by mass of starch, in which the granular product contains, as the starch, equal to or more than 3% by mass and equal to or less than 45% by mass of molecular weight-reduced starch of starch having an amylose content of equal to or more than 5% by mass, where the molecular weight-reduced starch has a peak molecular weight of equal to or more than 3×10³ and equal to or less than 5×10⁴, and the granular product has a degree of swelling of equal to or more than 5 and equal to or less than 20 in cold water at 25° C.

2. The production method according to claim 1,
wherein the blending amount of the component (A) is equal to or more than 0.2% by mass and equal to or less than 30% by mass with respect to the powder raw material.

3. The production method according to claim 1,
wherein a moisture content of the baked confectionery is equal to or more than 18% by mass and equal to or less than 45% by mass.

4. The production method according to claim 1,
wherein the baked confectionery is one selected from the group consisting of a pound cake, a roll cake, baumkuchen, a sponge cake, a pancake, a waffle, a corn dog, and a whoopie pie.

5. The production method according to claim 1,
wherein a content of the component (A) under a sieve having an opening of 0.5 mm is equal to or more than 65% by mass and equal to or less than 100% by mass.

6. The production method according to claim 1,
wherein the dough contains a cereal flour.

7. A dough of a baked confectionery, comprising:
a component (A) below,
wherein a moisture content (excluding moisture in a powder raw material) is equal to or more than 18% by mass and equal to or less than 55% by mass,
a blending amount of the component (A) with respect to the moisture content is equal to or more than 0.01 and equal to or less than 0.24, in terms of a mass ratio, and
the component (A) is a granular product containing equal to or more than 75% by mass of starch, in which the granular product contains, as the starch, equal to or more than 3% by mass and equal to or less than 45% by mass of molecular weight-reduced starch of starch having an amylose content of equal to or more than 5% by mass, where the molecular weight-reduced starch has a peak molecular weight of equal to or more than 3×10³ and equal to or less than 5×10⁴, and the granular product has a degree of swelling of equal to or more than 5 and equal to or less than 20 in cold water at 25° C.

8. A method for improving meltability in mouth of a baked confectionery,
wherein a moisture content (excluding moisture in a powder raw material) of a dough of a baked confectionery is equal to or more than 18% by mass and equal to or less than 55% by mass,
a component (A) below is contained in the dough of a baked confectionery, and
the component (A) is a granular product containing equal to or more than 75% by mass of starch, in which the granular product contains, as the starch, equal to or more than 3% by mass and equal to or less than 45% by mass of molecular weight-reduced starch of starch having an amylose content of equal to or more than 5% by mass, where the molecular weight-reduced starch has a peak molecular weight of equal to or more than 3×10³ and equal to or less than 5×10⁴, and the granular product has a degree of swelling of equal to or more than 5 and equal to or less than 20 in cold water at 25° C.
